(19) United States
(12) Patent Application Publication
(10) Pub. No.: US 2006/0045196 A1
(43) Pub. Date: Mar. 2, 2006

(54) Reduced state sequence estimator using multi-dimensional set partitioning

(76) Inventor: Tony Reid, Plano, TX (US)

Correspondence Address: Robert H. Kelly;Scheef & Stone, L.L.P., Suite 1400, 5956 Sherry Lane, Dallas, TX, 75225, US

(21) Appl. No.: 10/932,885

(22) Filed: Sep. 2, 2004

(51) Int. Cl. H04L 5/12

(52) U.S. Cl. 375/261

(57) ABSTRACT

A reduced state sequence estimator, and associated method, for equalizing data symbols communicated during operation of a communication system. The estimator is formed of multi-dimensional states of groups of symbols that are combined over more than one dimension to the multi-dimensional. Once the groups of symbols are formed, the groups are partitioned into partition sets. Equalization operations are performed over multiple time epochs of the trellis formed of the partitioned groups of symbols over multiple time epochs.

The present invention relates generally to a manner by which to perform reduced state sequence estimation using multi-dimensional set partitioning. More particularly, the present invention relates to apparatus, and an associated method, by which to estimate values of data symbols of a data sequence received at a communication station, such as a communication station operable in an N-OFDM (non-orthogonal frequency division multiplexed) system in which cyclic prefixes are not used.

Through use of the reduced state sequence estimation that has a trellis formed of multi-dimensional set partitions, equalization operations by which to estimate the values of the data symbols transmitted thereto exhibit desired performance levels while at reduced complexity levels relative to conventional reduced state sequence estimation procedures. Equalization is performed upon received data symbols that are communicated in a spectrally-efficient manner, e.g., without use of cylic prefixes, while maintaining acceptable performance levels at relatively low levels of complexity.

### BACKGROUND OF THE INVENTION

Communication systems that provide for the communication of data are pervasive throughout modern society. Ready access by users to communication systems is, many times, a practical necessity of modern society.

A communication system is formed, at a minimum, of a set of communication systems in which at least one of the communication stations forms a sending station and another of the communication stations of the set forms a receiving station. The communication stations are interconnected by way of a communication channel. When data is communicated by a sending station, the sending station sends the data upon the communication channel for delivery to the receiving station. The receiving station detects delivery of the data thereto, and the receiving station recovers the informational content of the data that is delivered thereto.

Different types of communication systems, which exhibit different communication capabilities, have been developed and deployed, used to provide different types of communication services. And, as technological advancements permit, new types of communication systems, making use of advancements in technologies, are undergoing development and deployment.

A radio communication system is an exemplary type of communication system. In a radio communication system, data is communicated between communication stations by way of radio communication channels. The radio communication channels are defined upon radio links, i.e., non-wireline links, that extend between the communication stations. Use of radio channels upon which to communicate data obviates the need to interconnect the communication stations by way of wireline connections. And, as a result, communications are effectuable by way of a radio communication system using communication stations positioned at locations at which communications would not be permitted by way of wireline communication systems. Increased availability of communications is thereby sometimes provided through the use of radio communication systems. Also, a radio communication system is implementable as a mobile communication system in which one or more of the communication stations is provided with communication mobility.

A cellular communication system is an exemplary type of radio communication system. The network parts of successive generations of cellular communication systems have been deployed, now to encompass significant portions of the populated areas of the world. The telephonic communication is effectuable by a, e.g., mobile station with the network part of a cellular communication system with which the mobile station is operable. Early-generation cellular communication systems provided for only limited data communication services. Successor generation communication systems are increasingly able to provide data intensive communication services.

So-called, fourth generation communication systems, for instance, are undergoing development. When deployed, a fourth-generation, cellular communication system shall need to be capable of communicating data at high data rates in a spectrally efficient manner. At least one proposal for a fourth-generation system provides for a non-orthogonal OFDM (N-OFDM) communication scheme. Waveforms proposed to be generated during operation of the N-OFDM system do not include cyclic prefixes, such as filter bank multi-carrier wavelets, to mitigate intersymbol interference (ISI). High-bandwidth channels are proposed of frequency sizes of, e.g., 12.5 and 100 MHz. Large delay spreads are possible on the channels. For example, when implemented in an urban environment, a symbol equalizer forming part of a receiving station might need to include two hundred channel taps when operating upon a 100 MHz bandwidth signal and twenty-five channel taps when operating upon a 12.5 MHz bandwidth signal. N-OFDM waveforms of high spectral efficiency might require enough frequency selectivity to require use of an equalizer. The equalizer must be of high-performance capabilities to compensate for longer delay spread channels, while at the same time be of relatively low complexity levels.

The use of reduced state sequence estimation is available in at least one existing cellular communication system, a GSM/EDGE (global system for mobile communications/enhanced data for GSM evolution) system using one-dimensional set partitioning. And, in at least one MIMO (multiple input, multiple output) system, the use of reduced state sequence estimation is extended through the use of Cartesian products over the reduced sets from one-dimensional set partitioning. And, proposals have been set forth by which to form set partitioning over multi-dimensional constellations.

As communications in the so-called, fourth-generation cellular communication system shall operate at higher spectral bands having higher number of taps in the channel delay spread and because spectral efficiency requirements necessitate the consideration of waveforms that might introduce frequency selectivity over the bandwidth in which signals are communicated, additional improvements to reduced state sequence estimation procedures would be beneficial.

It is in light of this background information related to communications in a radio communication system that the significant improvements of the present invention have evolved.

### SUMMARY OF THE INVENTION

The present invention, accordingly, advantageously provides apparatus, and an associated method, by which to perform reduced state sequence estimation using multi-dimensional set partitioning.

Through operation of an embodiment of the present invention, a manner is provided by which to estimate values of data symbols of a data sequence received at a communication station, such as a communication station operable in an N-OFDM (non-orthogonal frequency duplex modulation) system in which cyclic prefixes are not used.

Multi-dimensional set partitions are defined over successive time epochs, and a trellis is constructed between the set partitions of the successive epochs. Equalization of a received data sequence is performed by calculating minimum distance paths along the trellis.

Multiple channel symbols are collected, and set partitioning is performed over multiple dimensions defined by Cartesian products over multiple symbols. The partitioning provides for more potential reduced states that provide different performance and complexity trade-offs. Additionally, performance of set partitioning over multiple symbols improves equalization performance as more symbols are used in the edge transitions of the reduced state sequence estimation trellis. Reduced state sequence estimation is performed using a larger set of trellis sub-sets relative to a conventional reduced state sequence estimation procedure as set partitioning is performed over multiple symbols, i.e., dimensions. Increased performance/complexity options for equalization are increased. Additionally, through further operation of an embodiment of the present invention, the set-partitions are designed using linear block codes that shape the sub-set trellises to give different minimum square sub-set distances for sub-set trellis choices. And, additionally, metric calculations over each edge transition in the reduced state trellis have higher probability of selection of the correct symbols.

In one aspect of the present invention, states are defined by groups of symbols, combined over two dimensions. And, once the states are defined, the states are partitioned into partition sets. Equalization operations, when performed, utilize distance metric calculations that calculate the minimal-distance path between partition sets of the successive epochs.

In another aspect of the present invention, the states, formed of the two, or more, dimensions, are encoded prior to partitioning the states into partition sets. Encoding is performed, e.g., by interleaving the states in a desired arrangement and then partitioning these states into partition sets. Desired distance characteristics are better obtainable through the use of encoding to position the states in selected orders and then partitioning the states into set partitions.

In one implementation, reduced state sequence estimation is used in a communication system that operates pursuant to an N-OFDM communication scheme. The data sequences forming waveforms are communicated to a receiving station, and representations of the values of the receive data sequence are provided to a reduced state sequence estimator. The reduced state sequence estimator is formed of multi-dimensional states defined, e.g., over two dimensions, in which, once formed, the states are partitioned into partition sets. Paths extending between the partition sets of successive epochs of time are defined, and pursuant to equalization operations, minimum distance metric paths are determined.

Better Euclidean distance properties of the symbol subsets for trellis states results in improved performance gain over single dimensional set partitioning with a comparable time computational complexity. That is to say, there are fewer states but there are more computations per state. For long delay spread channels the channel is “shortened” by grouping symbols L at a time for a channel N taps. The channel length is essentially shortened as the length becomes N/L taps. This channel length shortening permits allocation of more taps in a maximum likelihood sequence estimation/decision feedback equalizer (MLSE/DFE) configuration, resulting in improved performance. Additionally, more accurate estimates over groups of feedback symbols instead of single symbols are provided, lessening problems associated with error propagation.

In these and other aspects, therefore, apparatus, and an associated method, is provided for a communication station. The communication station is operable at least to receive a data sequence formed of data symbols. An estimator is adapted to receive indications of values of the data symbols of the data sequence. The estimator is formed of multi-dimensional states of groups of symbols that are combined over more than one dimension. Once combined, the groups of symbols are partitioned into partition sets. The estimator estimates values of the data symbols of the data sequence.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of an exemplary communication system in which an embodiment of the present invention is operable.

FIG. 2 illustrates an exemplary representation of partitioning performed in a single dimensional reduced state sequence estimation scheme to form set partitions of an 8-PSK (phase shift keying) constellation set.

FIG. 3 illustrates an exemplary trellis formed pursuant to a 4-tap reduced state sequence estimation scheme.

FIG. 4 illustrates a representation of exemplary set partitioning of a two-dimensional partitioning scheme.

FIG. 5 illustrates a representation of a multi-dimensional set partitioning scheme of an embodiment of the present invention.

FIG. 6 illustrates an exemplary set partition composition formed pursuant to operation of an embodiment of the present invention.

FIG. 7 illustrates a table representative of set partitions formed pursuant to an embodiment of the present invention.

FIG. 8 illustrates representations of weight spectra of one-dimensional and two-dimensional set partitioning.

FIG. 9 illustrates an exemplary trellis formed pursuant to operation of an exemplary implementation of an embodiment of the present invention.

### DETAILED DESCRIPTION

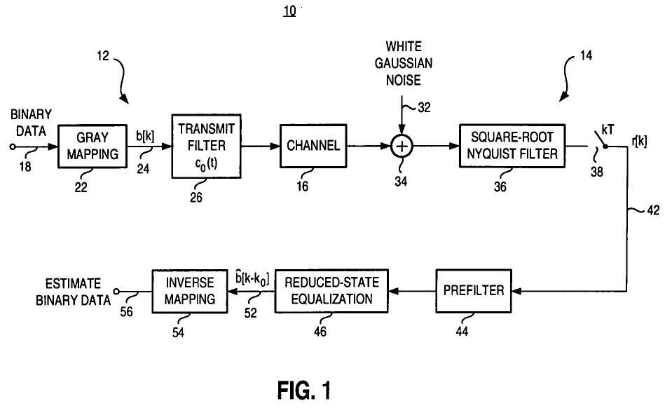

Referring first to FIG. 1, an exemplary communication system, shown generally at 10, provides for communication of data between a set of communication stations, here a sending station 12 and a receiving station 14. The sending and receiving stations are interconnected by way of a channel 16.

In the exemplary implementation, the communication system 10 forms a non-orthogonal-OFDM (orthogonal frequency division multiplex) communication system in which the channel 16 is formed of a sub-carrier of a group of sub-carriers of a selected carrier frequency. The sub-carriers are non-orthogonally related to one another and each define channels upon which data sequences, such as data frames formed of data symbols are communicated. While the following description shall describe exemplary operation of an embodiment of the present invention with respect to its implementation in the communication system 10 in which the communication system 10 forms an N-OFDM communication system, such as that proposed for a fourth-generation, cellular communication system, it should be understood that an embodiment of the present invention is analogously implementable to be operable in communication systems of other constructions. Description of operation of an embodiment of the present invention in another type of communication system is analogous to description of its exemplary implementation in the N-OFDM communication system 10.

Binary data formed on the line 18 is provided to the sending station and is mapped into map symbol values by a mapper 22 on the line 24. Filtering of the mapped values is performed by a transmit filter 26, and the mapped values forming symbols are caused to be communicated upon the channel 16. Interferences introduced upon the signal during its communication upon the channel. Here, for instance, white Gaussian noise is introduced upon the signal, indicated by the line 32 extending to the summing element 34 at which the Gaussian noise is added to the channel-transmitted data.

The receiving station includes a filter 36 that operates to filter received signals detected at the receiving station. Filtered representations are provided to a sampler 38 that samples the filtered values and generates sample representations r(k) on the line 42. The sampled representations are filtered by a prefilter 44 and then applied to a reduced-state sequence estimator 46 at which reduced-state equalization procedures are carried out pursuant to an embodiment of the present invention. And, estimated values formed by the estimator 46 are provided on the line 52 to an inverse mapper 54. The inverse mapper operates generally reverse to that of the mapper 22 and generates estimated binary data on the line 56.

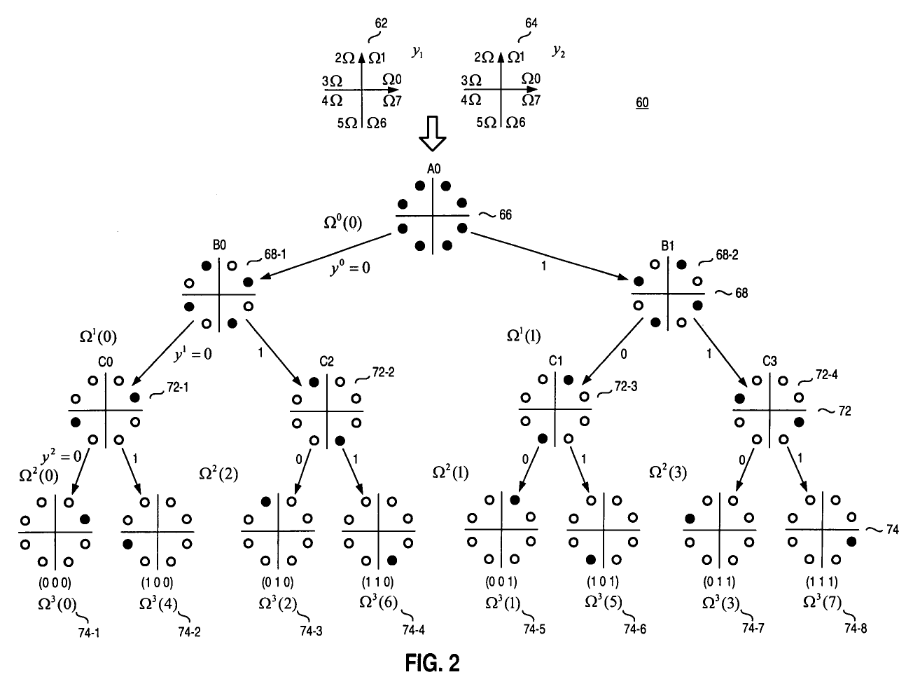

FIG. 2 illustrates a graphical representation, shown generally at 60, of an exemplary set-partitioning scheme for 8-PSK symbol constellations. Here, two x-PSK constellations 62 and 64 are shown. The partitioning is defined in terms of levels, and, here, an initial level 66, a first partition level 68, a second partition level 72, and a third partition level 74. At the initial level 66, the constellation set is formed of all eight symbols of the 8-PSK constellation set.

At the first level 68, set partitioning partitions the symbols into first and second partition sets, set 68-1 and 68-2. At the second level 72, four partition sets are formed, partition sets 72-1, 72-2, 72-3, and 72-4. And, at the third level 74, eight partition sets, sets 74-1, 74-2, 74-3, 74-4, 74-5, 74-6, 74-7, and 74-8 are formed. At each level, a constellation point belongs to a particular set-partition.

The estimator 46 of the receiving station 14 (shown in FIG. 1) includes partition sets such as those defined at a selected one of the levels, such as the level 68, 72, and 74. And a trellis, formed of trellis nodes, is defined by the set partitions formed of the partition sets into which the constellation symbols are divided. That is to say, the constellation points are members of set partitions where each trellis node is a set partition at a particular level. For example Ω¹(0), Ω¹(1) are the 2 set-partitions at level 68. Each set has 4, 8-PSK constellation points. For a 1-tap Rayleigh, fading channel this scheme for defining subset trellis nodes would result in 2 trellis nodes at each stage. However for a MLSE with a Viterbi decoder there would be 2³=8 trellis nodes at each stage (i.e. 8-PSK modulation). There would be 8 edge transitions for each trellis node for each case. Therefore the inherent computational complexity of the RSSE is less than a Viterbi decoder. If 4 sub-trellis nodes are desired then Ω²(0), Ω²(1), Ω²(2), Ω²(3) are four sub-set trellis nodes at partition level 72.

The strength of reduced state sequence estimation is more apparent when the channel has more taps. For example, a ²-tap channel (i.e. L=2) and 8-PSK modulation requires 8^{L}=64 states for a Viterbi equalizer. The construction of a reduced state equalizer uses two rules. Letting J⁽ⁱ⁾ be defined as the number of subset trellis states at each partition level (i), then for each partition level J^{(K)}≧J^{(K-1})≧ . . . J^{(1)≧J}⁽⁰⁾. This follows because Ω^{K}(●)⊂Ω^{K-1}(●)⊂. . . ⊂Ω¹(●)⊂Ω⁰(●). The actual sub-set trellis nodes are constructed by taking Cartesian products over sets of subset trellis nodes at each channel tap. However the number of subset-trellis nodes used for the Cartesian products is over a succession of sub-set trellis nodes with fewer states. For example, when L=2 a valid set of subset nodes would be J⁽²⁾×J⁽¹⁾=4×2=8 states. Another valid case would be J⁽³⁾×J⁽¹⁾=8×2=16 states. The reason for this precedence relation of subset-trellis nodes is that as a symbol constellation point that is a member of a particular subset-trellis progressives through the channel, the constellation point moves from set partitions of fewer constellation points to set partitions with a larger sets of constellations points. Review of FIG. 2 shows that any constellation point xᵢ in set partition Ω²(0) would become a member of Ω¹(0) at the next “lower” partition level. The symbol xᵢ in a 2-tap channel would progress from a set of sub-set trellis nodes where J⁽²⁾=4 states to a set of subset trellis nodes where J⁽¹⁾=2 states. Therefore the precedence relation between the number of sub-set trellis nodes at each channel tap is J⁽ⁱ⁾≧J^{(k)}≧ . . . ≧J^{(l)}≧J^{(m)}. For all possible constellation points the total number of nodes at each stage of subset trellis nodes would be J⁽ⁱ⁾×J^{(k)}× . . . ×J^{(l)}×J^{(m)}.

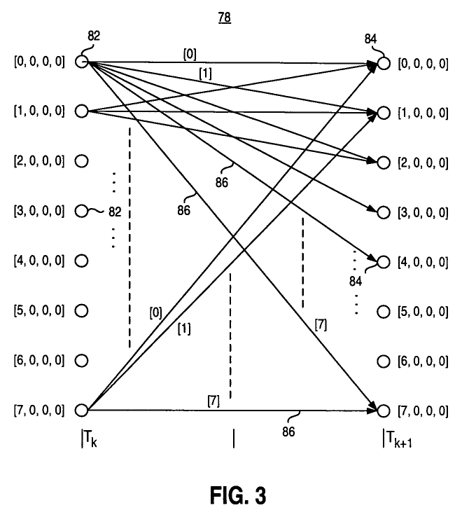

FIG. 3 illustrates a trellis, shown generally at 78, representative of a four-tap channel. One subset-trellis stage is shown in the figure. Trellis nodes 82 and 84 each and paths 86 interconnecting the nodes are represented in the figure.

An admissible progression of subset trellis nodes would be J₁⁽³⁾≧J₂⁽⁰⁾≧J₃⁽⁰⁾≧J₄⁽⁰⁾. The total number of sub-set trellis nodes at each trellis stage would be J₁⁽³⁾×J₂⁽⁰⁾×J₃⁽⁰⁾×J₄⁽⁰⁾=8×1×1×1=8 sub-set trellis nodes. The number of possible edge transitions per subset trellis nodes would be 8 for 8-PSK. The state of each sub-set trellis node would be determined by estimates \hat{x}ᵢ of a symbol at time i for 4 symbols. The subscript notation for each Jᵢ^{(k)} represents the number of sub-set trellis nodes possible for the progression of one symbol \hat{x}ᵢ through the trellis from a previous time \hat{x}ᵢ₋₁. A Viterbi trellis for 8-PSK would require 8⁴=4096 states. There are 8 edge transitions per sub-set trellis node. The destination node for each edge transition is based on membership in the set partitions at the next stage of the sub-set trellis. Notice it is not necessary that the next sub-trellis node be at a set partition level directly above the previous level (e.g. since Ω⁰(●)⊃Ω³(●)). The state labels are associated with the admissible set partitions that are in the node state. For an RSSE for a 4-tap channel, then the first node is a member of 1 of the 8 possible set-partitions associated with level 74. The remaining 3 entries are associated with the one set partition associated with level 66. Therefore the node label is [0,0,0,0].

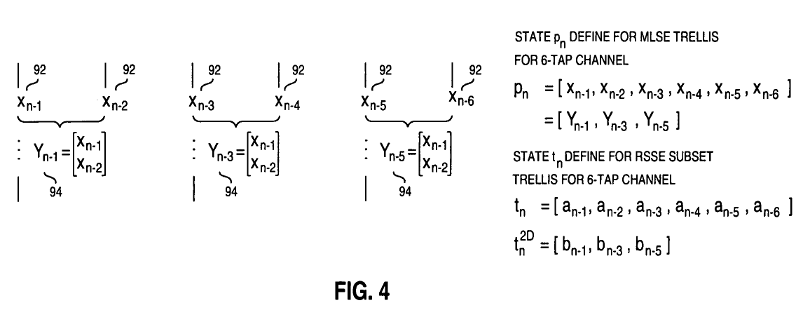

FIG. 4 illustrates a representation of exemplary multi-dimensional set partitioning, here over two dimensions, used pursuant to an exemplary embodiment of the present invention by which to form a trellis of a reduced state sequence estimator. Symbol times X are represented in the figure at 92, shown at six separate time instances over the consecutive time instances, consecutive symbols, e.g., L, are formed and Cartesian products are formed over elements in each constellation. Here, binary-tuple representations are formed, represented at 94, for each point in a two-dimensional space. And, a set of (Lnd) block codes are set for multi-level set partitioning. And, partitioning of a superset is performed down to lowest partition levels.

For example, each node for a 6-tap, fading channel using a Viterbi trellis or 1-dimensional RSSE would have 6 elements for each node. This is denoted as pₙ=[xₙ₋₁, xₙ₋₂, xₙ₋₃, xₙ₋₄, xₙ₋₅, xₙ₋₆]for a Viterbi trellis. For an RSSE, a subset trellis node would be represented by a state tₙ=[aₙ₋₁, aₙ₋₂, aₙ₋₃, aₙ₋₅, aₙ₋₆] where each aᵢ represents a subset trellis node with a particular symbol estimate \hat{x}ᵢεaᵢ. A new 2-dimensional sub-set trellis is constructed by forming 2-tuples for sets of symbols denoted as

$${Y}_{n - 1} = [ \begin{matrix}{x}_{n - 1} \\ {x}_{n - 2}\end{matrix} ] , \qquad {Y}_{n - 3} = [ \begin{matrix}{x}_{n - 3} \\ {x}_{n - 4}\end{matrix} ] , \qquad {Y}_{n - 5} = [ \begin{matrix}{x}_{n - 5} \\ {x}_{n - 6}\end{matrix} ] .$$

A Viterbi trellis constructed has the same number of states with this grouping. However a RSSE constructed over 2-tuples has a different structure than an RSSE constructed over 1-tuples. Now with 2-tuples, the set partitioning must be performed over all 2-tuples and each edge transition in the sub-set trellis is also over a 2-tuple of symbols. The new sub-set trellis has new representation tₙ^{2D}=[bₙ₋₁, bₙ₋₃, bₙ₋₅]where

$${\hat{Y}}_{n - 1} = [ \begin{matrix}{\hat{x}}_{n - 1} \\ {\hat{x}}_{n - 2}\end{matrix} ] ∈ {b}_{n - 1} .$$

The steps needed to form an RSSE over M-tuples are as follows: For a set of M-consecutive symbols, form Cartesian products over elements in each constellation. A labeling scheme is formed, for instance, for constellations points based on “natural” ordering; for multilevel set partitioning, pick a set of (M, N, dₘᵢₙ) block codes, which are used to construct the set partitions over multi-dimensional M-tuples where M is the codeword length, N is the number of message bits in the codeword and dₘᵢₙ is the minimum Hamming distance; perform partitioning of superset down to lowest partition levels; now with the set-partitions defined the mechanics of picking a particular number of sub-set trellis nodes and constructing a sub-set trellis stage is the same as the constructions for 1-D RSSE.

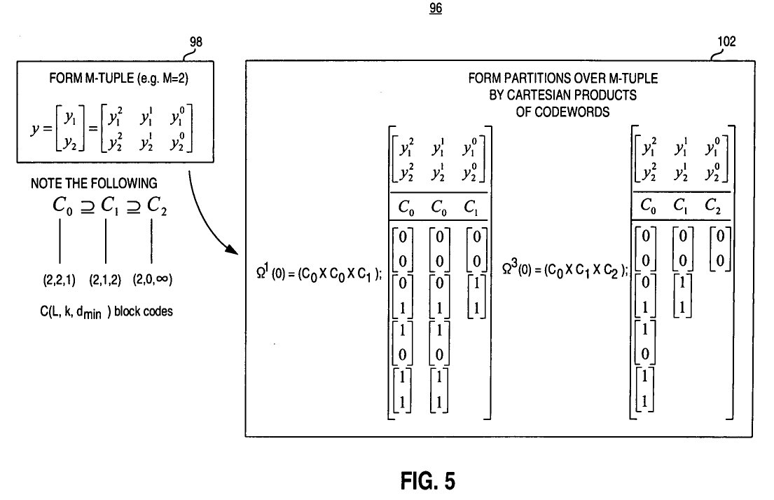

FIG. 5 illustrates a representation shown generally at 96, of the formation of set partitioning pursuant to an embodiment of the present invention. First, and as indicated by the block 98, a M-tuple is formed. Here, M equals 2. Then, and as illustrated by the block 102, partitions over the M-tuple are formed by Cartesian products of codewords.

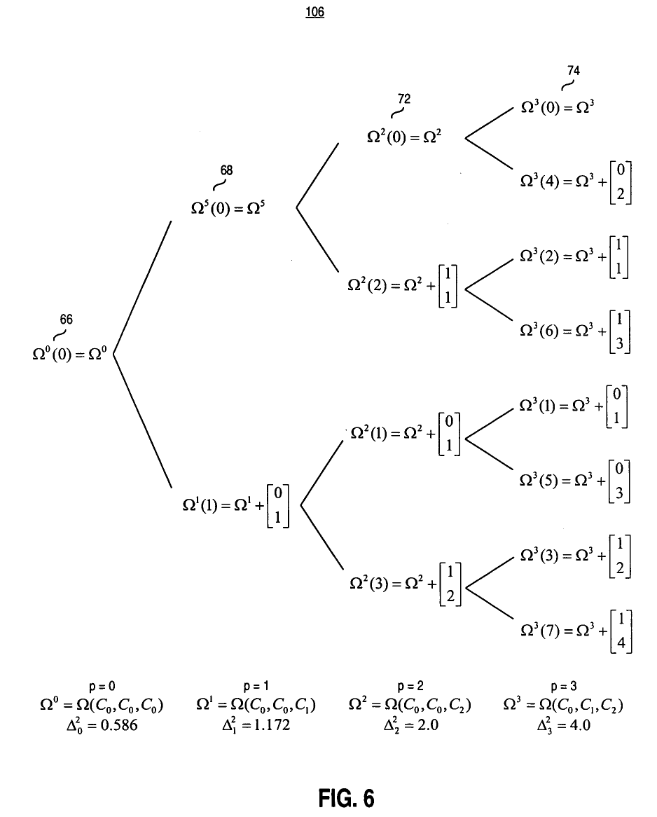

FIG. 6 illustrates exemplary set partitions, shown generally at 106, formed pursuant to operation of an embodiment of the present invention. Initial, first, second, and third levels 66′, 68′, 72′, and 74′ are shown in the figure.

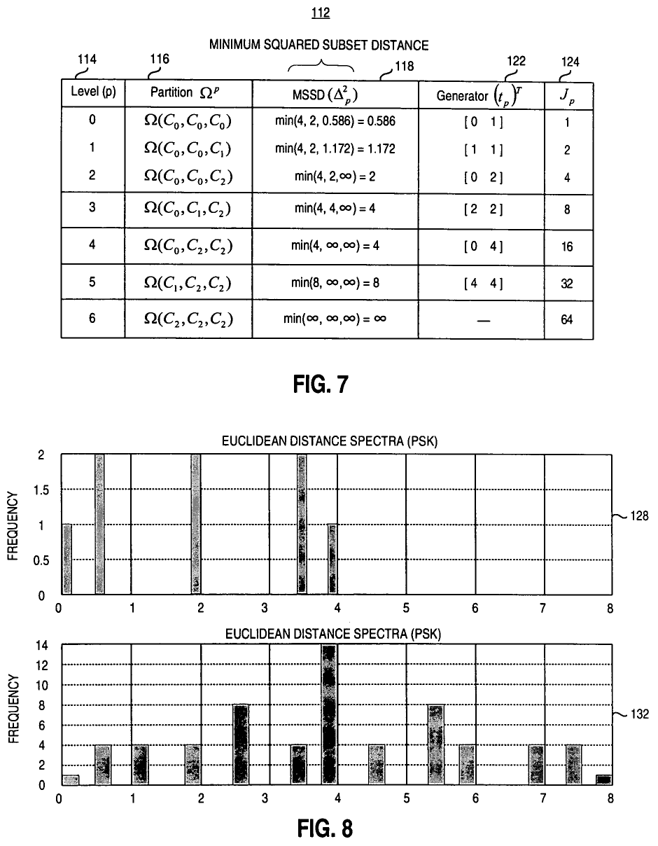

FIG. 7 illustrates a table 112 identifying the set partitions generated with a particular set of codewords for two-dimensional 8-PSK. Column 14 shows the partition levels (p). The last column 124 shows the number of sub-set trellis nodes Jₚ for each partition level (p). There are 6 partition levels for 2-D RSSE. There are 3 partition levels for 1-D RSSE. The maximum MSSD is 8 for 2-D RSSE, while for 1-D RSSE the maximum MSSD is 4. For a 2-D RSSE, either sub-set trellis nodes for partition level 3 or 4 have the same MSSD. This implies that fewer sub-set trellis states could be used to give the same “performance” in a MSSD sense. Another figure of merit to be considered is the codeword weight spectra relative to the all zeros codeword. (If geometric uniformity of codewords were proven, then this would be a more reasonable metric. At this point this has not been proven.)

FIG. 8 illustrates comparison of the weight spectra 128 and 132 of 1-D RSSE and 2-D RSSE for 8-PSK. For 2-D RSSE, the Euclidean weight spectra is shifted to the right relative to 1-D RSSE. This is usually a desirable trait of a coding scheme. A 2-D RSSE exploits the properties of the underlying codes used to provide set partitioning to enhance the performance—at least in a MSSD sense.

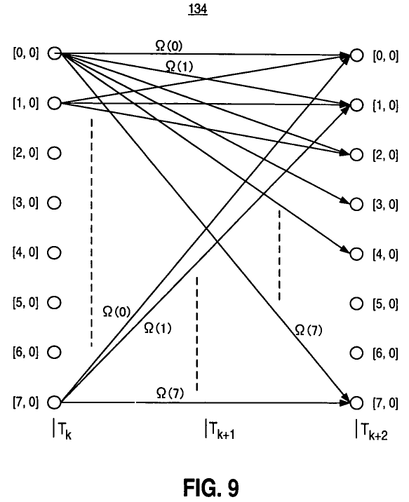

FIG. 9 shows a RSSE sub-set trellis 134 for 2-D 8-PSK for a 4-tap channel as considered for 1-D RSSS. For J₁³, J₂⁰=[8,1] there are J₁³×J₂⁰=8 sub-set trellis nodes per stage. Note also that each trellis stage occurs at every other time epoch. The admissible edge transitions between nodes is determined by 2-tuples having membership in partitions Ω³(0),Ω³(1), . . . Q³(7). The node-labelling scheme is the same as the 1-D RS SE. The first node label entry corresponds to 1 of 8 possible set partitions at level (3). The second node label entry corresponds to one set partition at level (0). There are only 2 entries since each symbol is a 2-tuple. As shown a 2-tuple originating at node state [0,0] will have destination of state [0,0] if the 2-tuple

$$[ \begin{matrix}{x}_{i} \\ {x}_{i - 1}\end{matrix} ] ∈ {Ω}^{3} ( 0 ) = \{ [ \begin{matrix}0 \\ 0\end{matrix} ] , [ \begin{matrix}0 \\ 4\end{matrix} ] , [ \begin{matrix}2 \\ 2\end{matrix} ] , [ \begin{matrix}2 \\ 6\end{matrix} ] , [ \begin{matrix}4 \\ 0\end{matrix} ] , [ \begin{matrix}4 \\ 4\end{matrix} ] , [ \begin{matrix}6 \\ 2\end{matrix} ] , [ \begin{matrix}6 \\ 6\end{matrix} ] \}$$

where each 2-tuple is specified by an address label.

Because reduced state sequence estimation is performed utilizing multiple dimension set partitions, various improvements are provided. There are more partition levels from which to select sub-set trellis nodes, thereby facilitating design flexibility of the reduced state sequence estimator. Additionally, block codes can be used for the set-partitioning. Changes in the Euclidean distance properties are permitted of the minimum mean square sub-set distance (MSSD) of the set partitions pursuant to the equalization operations. For different block code choices, the distance at one set partition level can be different. In other situations, the distance can be the same across different partition levels. This permits complexity to be reduced if a smaller number of trellis nodes are used. Further, metric calculations on edge transitions are performed over more symbols, implying that the error surface has a larger peak and smaller variance than corresponding metric calculations for one symbol. For each M-tuple, the processing time for computation is done at every M-th time epoch instead of for each symbol. Additionally, performance is enhanced with iterative processing.

The previous descriptions are of preferred examples for implementing the invention, and the scope of the invention should not necessarily be limited by this description. The scope of the present invention is defined by the following claims.

What is claimed is:

1. Apparatus at a communication station operable at least to receive a data sequence formed of data symbols, said apparatus comprising:
an estimator adapted to receive indications of values of the data symbols of the data sequence, said estimator formed of multi-dimensional sets of groups of symbols combined over more than one dimension that, once combined, are partitioned into partition sets, said estimator for estimating values of the data symbols of the data sequence.

2. The apparatus of claim 1 wherein the partition sets into which the groups of symbols forming said estimator are partitioned are selected responsive to a selected property associated therewith.

3. The apparatus of claim 2 wherein the selected property associated with the partition sets into which the groups of symbols are partitioned comprise a distance property.

4. The apparatus of claim 3 wherein the groups of symbols are partitionable into a first group of partition sets and at least a second group of partition sets, the groups of symbols divided into a selected one of the first and second groups of partition sets, respectively, responsive to the distance property.

5. The apparatus of claim 4 wherein the selected one of the first and second groups of partition sets into which the groups of symbols are divided exhibits at least relative maximal separation distances.

6. The apparatus of claim 5 wherein the at least the relative maximal separation distances comprise maximal separation distances normalized as a function of processing complexity.

7. The apparatus of claim 1 wherein the multi-dimensional states of the groups of the symbols of which said estimator is formed comprise two-dimensional states.

8. The apparatus of claim 1 wherein estimated values estimated by said estimator are estimated responsive to path metric calculations between partition sets embodied at successive time epochs.

9. The apparatus of claim 8 wherein the estimated values are defined by states that exhibit maximal path metrics.

10. The apparatus of claim 1 wherein the data sequence comprises a sequence of data symbols communicated between a sending station and a receiving station of a radio communication system that utilizes an N-OFDM communication scheme and wherein said estimator is embodied at the receiving station.

11. The apparatus of claim 1 wherein the groups of the symbols of which said estimator is formed, once combined, are encoded prior to partitioning into the partition sets.

12. A method for equalizing a data sequence formed of data symbols to estimate values of the data symbols, said method comprising the operations of:
combining symbols of which the data sequence is formable into groups of symbols over more than one dimension;
partitioning the groups of symbols, combined during said operation of combining, into partition sets to form a reduced sequence trellis; and
determining estimated values of the data symbols by applying detected values of the data symbols to the reduced sequence trellis formed pursuant to said operation of partitioning.

13. The method of claim 12 further comprising the operation, prior to said operation of partitioning, of encoding the groups of symbols according to a selected encoding scheme.

14. The method of claim 13 wherein said operation of encoding comprises interleaving the groups of symbols.

15. The method of claim 12 wherein the partition sets into which the groups of symbols are partitioned during said operation of partitioning are selected according to a selected property.

16. The method of claim 15 wherein the selected property according to which the groups of the symbols are partitioned during said operation of partitioning comprises a distance property.

17. The method of claim 12 wherein the groups into which the symbols are formed during said operation of forming comprises groups of symbols over two dimensions.

18. The method of claim 12 wherein the estimated values determined during said operation of determining are determined by performing path metric calculations between partition sets embodied at successive time epochs of the reduced sequence trellis.

19. The method of claim 12 wherein the data sequence comprises a sequence of data symbols communicated between a sending station and a receiving station of a radio communication system that utilizes an N-OFDM communication scheme and wherein said operations of combining, partitioning, and determining are performed at the receiving station.

20. The method of claim 19 wherein the sequence of data symbols is formatted into a frame free of a cyclic prefix and wherein said method further comprises the operation, prior to said operation of determining, of detecting delivery of the sequence of data at the receiving station.
